(19) United States
(12) Patent Application Publication
(10) Pub. No.: US 2020/0202298 A1
(43) Pub. Date: Jun. 25, 2020

(54) CUTTING MACHINE SUPPLYING & MARKETING DLT-BASED SYSTEM AND METHOD THEREOF

(71) Applicant: COSEN MECHATRONICS CO., LTD., Hsinchu City (TW)

(72) Inventors: MU-SHUI HUANG, Hsinchu City (TW); YING-FAN WU, Hsinchu City (TW)

(21) Appl. No.: 16/722,797

(22) Filed: Dec. 20, 2019

(30) Foreign Application Priority Data
Dec. 24, 2018 (TW) 107146808

(51) Int. Cl. G06Q 10/08; G06Q 30/02; G05B 23/02

(52) U.S. Cl. CPC G06Q 10/0875; G06Q 30/0201; G05B 23/0283; G06Q 30/0234; G06Q 30/0202

(57) ABSTRACT

A cutting machine supplying & marketing DLT-based system is provided, which includes a plurality of sensors, a cloud analysis device, a cloud data ledger module and a cloud supplying module. The sensors are connected to a plurality of components of a target cutting machine implementing a cutting operation and each sensor provides the operation data of one of the components. The cloud analysis device analyzes the operation data of the components to generate analysis results and generates the healthy statuses of the components according to the analysis results. The cloud data ledger module records the healthy statuses of the components. The cloud supplying module transmits a component purchase reminder signal to a user device according to the healthy statuses of the components for the user device to make an order.

### CROSS REFERENCE TO RELATED APPLICATION

All related applications are incorporated by reference. The present application is based on, and claims priority from, Taiwan Application Serial Number 107146808, filed on Dec. 24, 2018, the disclosure of which is hereby incorporated by reference herein in its entirety.

### TECHNICAL FIELD

The technical field relates to a cutting machine supplying & marketing system, in particular to a cutting machine supplying & marketing DLT(Distributed ledger technology)-based system. The technical field further relates to the method of the system.

### BACKGROUND

Cutting machines (e.g. bandsaw machines, lathes, milling machines) are frequently-used industrial machines. Currently, a cutting machine supplier usually has a marketing system for marketing the cutting machines manufactured by the supplier and managing the inventory. However, the currently available marketing systems still have a lot of shortcomings needed to be improved.

For example, the currently available marketing systems can provide only the common marketing management and inventory management functions, but cannot actively promote the products. Thus, the currently available marketing systems cannot effectively increase the sales volume of the cutting machines.

Besides, the currently available marketing systems can provide only the common marketing management and inventory management functions, but cannot acquire the operational data of the cutting machines from the customers. Therefore, the suppliers cannot understand the actual performances of the cutting machines and the components thereof.

Moreover, the currently available marketing systems can record only the inventory of the cutting machines and the components thereof, but cannot obtain the demand of the customers, so the inventory of the cutting machines tends to be insufficient.

Accordingly, it has become an important issue to provide a cutting machine marketing system in order to improve the above problems of the currently available marketing systems.

### SUMMARY

An embodiment of the disclosure relates to a cutting machine supplying & marketing DLT-based system, which includes a target cutting machine data input module, a cloud data ledger module and a cloud supplying module. The target cutting machine data input module receives the basic data of the components, the workpieces and the operational status of a target cutting machine. The cloud data ledger module records the basic data. The cloud supplying module compares the basic data with an estimated component mechanical consumption data to generate a comparison result; when the comparison result is less than a threshold, the cloud supplying module transmits a component purchase reminder signal to a user device for the user device to make an order. The cloud supplying module receives an order signal transmitted from the user device in order to generate a transaction record.

Another embodiment of the disclosure relates to a cutting machine supplying & marketing DLT-based method, which includes the following steps: receiving the basic data of the components, the workpieces and the operation status of a target cutting machine by a target cutting machine data input module; recording the basic data by a cloud data ledger module; comparing the basic data with an estimated component mechanical consumption data to generate a comparison result and transmitting a component purchase reminder signal to a user device when the comparison result is less than a threshold by a cloud supplying module for the user device to make an order; and receiving an order signal transmitted from the user device and generating a transaction record according to the order signal by the cloud supplying module.

Still another embodiment of the disclosure relates to a cutting machine supplying & marketing DLT-based system, which includes a plurality of sensors, a cloud analysis device, a cloud data ledger module and a cloud supply module. The sensors are connected to a plurality of components of a target cutting machine implementing a machining process respectively to provide the operational data of the components. The cloud analysis device analyzes the operational data of the components to generate the analysis results of the components and generate the healthy statuses of the components according to the analysis results of the components. The cloud data ledger module records the healthy statuses of the components. The cloud supplying module transmits a component purchase reminder signal to a user device according to the healthy statuses of the components for the user device to make an order. The cloud supplying module receives an order signal transmitted from the user device to generate a transaction record.

Further still another embodiment of the disclosure relates to a cutting machine supplying & marketing DLT-based method, which includes the following steps: connecting a plurality of sensors to a plurality of components of a target cutting machine implementing a machining process respectively to provide the operational data of the components; analyzing the operational data of the components to generate the analysis results of the components and generating the healthy statuses of the components according to the analysis results of the components by a cloud analysis device; recording the healthy statuses of the components by a cloud data ledger module; transmitting a component purchase reminder signal to a user device according to the healthy statuses of the components by a cloud supplying module for the user device to make an order; and receiving an order signal transmitted from the user device to generate a transaction record by the cloud supplying module.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The disclosure will become more fully understood from the detailed description given herein below and the accompanying drawings which are given by way of illustration only, and thus are not limitative of the disclosure and wherein:

FIG. 1 is a block diagram of a cutting machine supplying & marketing DLT-based system in accordance with a first embodiment of the disclosure.

FIG. 2 is a flow chart of the first embodiment of the disclosure.

FIG. 3 is a block diagram of a cutting machine supplying & marketing DLT-based system in accordance with a second embodiment of the disclosure.

FIG. 4 is a flow chart of the second embodiment of the disclosure.

FIG. 5 is a block diagram of a cutting machine supplying & marketing DLT-based system in accordance with a third embodiment of the disclosure.

FIG. 6 is a first flow chart of the third embodiment of the disclosure.

FIG. 7 is a second flow chart of the third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

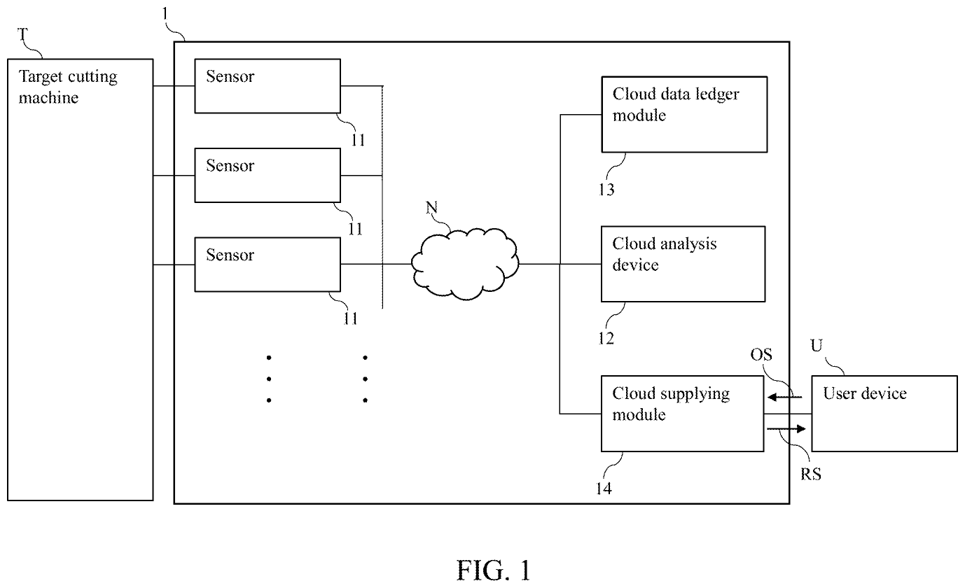

Please refer to FIG. 1, which is a block diagram of a cutting machine supplying & marketing DLT-based system in accordance with a first embodiment of the disclosure. As shown in FIG. 1, the system 1 includes a plurality of sensors 11, a cloud analysis device 12, a cloud data ledger module 13 and a cloud supplying module 14.

The sensors 11 are disposed on the target cutting machine T and connected to a plurality of components of the target cutting machine T respectively; the sensors 11 are further connected to the cloud analysis device 12, the cloud data ledger module 13 and the cloud supplying module 14 via a network N. The target cutting machine T implements a machining process for a workpiece; the sensors 11 detects the operational data of the components corresponding thereto respectively and provide the operational data of the components. In one embodiment, the sensors 11 may include two or more of a vibration sensor, a temperature sensor, a sound sensor, an image sensor or other similar sensors. In one embodiment, the components may include one or more of a bandsaw, a steel brush, a cutting oil tank, a gear box, a motor, a spindle, etc. In one embodiment, the operational data of each of the component may include one or more of a vibration signal, a temperature signal, an image signal, a sound signal, etc.

The cloud analysis device 12 can generate the analysis results of the components by analyzing the operational data of the components via distributed ledger technology, and generate the healthy statuses of the components according to the analysis results of the components. In one embodiment, the healthy status of the component may be the residual service life, the number of the residual cutting time or the damage status of the component.

The cloud data ledger module 13 records the healthy statuses of the components.

The cloud supplying module 14 transmits a component purchase reminder signal RS to the user device U according to the healthy statuses of the components. More specifically, the cloud supplying module 14 can generate the component purchase reminder signal RS according to the healthy statuses of the components and a purchase condition which the user agrees. For instance, if the purchase condition includes purchasing a spare for one component in advance when the residual service life of the components is less than one month, the cloud supplying module 14 can generate the component purchase reminder signal RS and transmit the component purchase reminder signal RS to the user device U when the residual service life of the component is less than one month.

Then, the user device U transmits an order signal OS to the cloud supplying module 14 according to the component purchase reminder signal RS. Afterward, the cloud supplying module 14 generates a transaction record according to the order signal OS. Via the above method, the user can purchase enough spares for the components before the components need to be replaced, so the cutting machines of the user can always work normally.

In addition, the cloud supplying module 14 can further calculate reward values or cash back according to the data volume of the operational data, transmitted by the sensors 11, of the components and record the reward values or cash back in the user account of the user device U. Via the above method, when the user transmits the order signal OS to make the order, the reward values or cash back can serve as the discount in the payment, so the user will be more willing to provide more operational data for analysis, and purchase more cutting machines and the components thereof. Therefore, the above method can also effectively increase the sales volume of the supplier's products.

The embodiment just exemplifies the disclosure and is not intended to limit the scope of the disclosure. Any equivalent modification and variation according to the spirit of the disclosure is to be also included within the scope of the following claims and their equivalents.

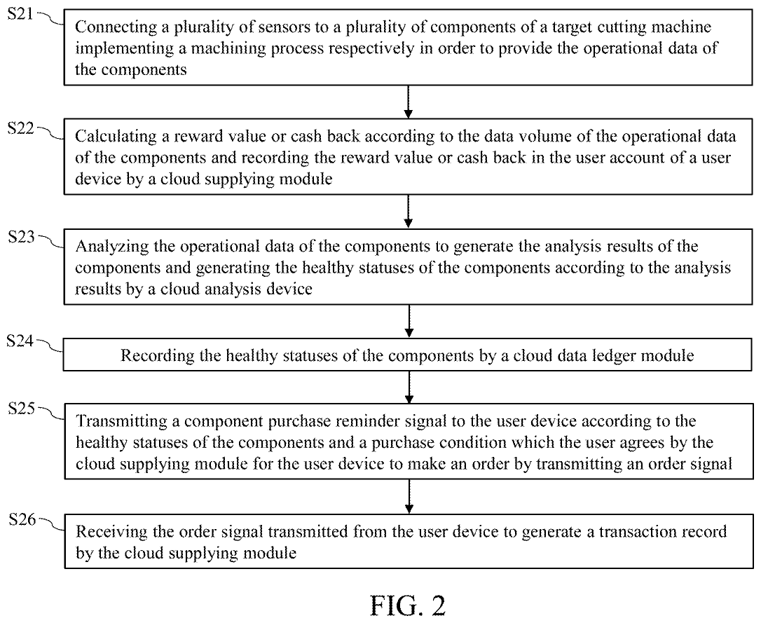

Please refer to FIG. 2, which is a flow chart of the first embodiment of the disclosure. As shown in FIG. 2, the cutting machine supplying & marketing method in accordance with the first embodiment may include the following steps:

Step 21: connecting a plurality of sensors to a plurality of components of a target cutting machine implementing a machining process respectively in order to provide the operational data of the components.

Step 22: calculating a reward value or cash back according to the data volume of the operational data of the components and recording the reward value or cash back in the user account of a user device by a cloud supplying module.

Step S23: analyzing the operational data of the components to generate the analysis results of the components and generating the healthy statuses of the components according to the analysis results by a cloud analysis device.

Step S24: recording the healthy statuses of the components by a cloud data ledger module.

Step S25: transmitting a component purchase reminder signal to the user device according to the healthy statuses of the components and a purchase condition which the user agrees by the cloud supplying module for the user device to make an order by transmitting an order signal.

Step S26: receiving the order signal transmitted from the user device to generate a transaction record by the cloud supplying module.

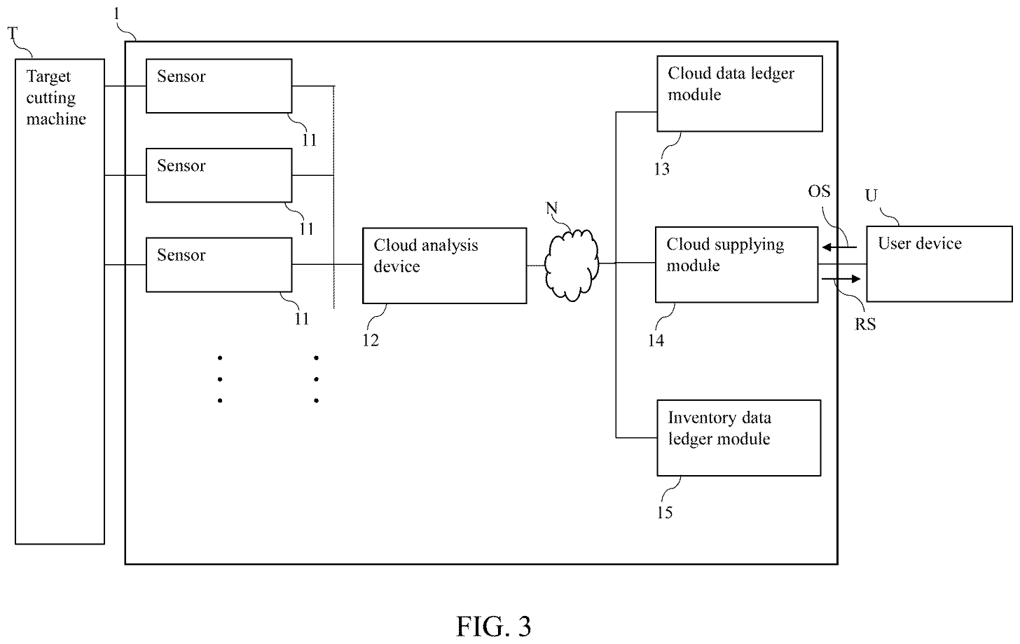

Please refer to FIG. 3, which is a block diagram of a cutting machine supplying & marketing DLT-based system in accordance with a second embodiment of the disclosure. As shown in FIG. 3, the system 1 includes a plurality of sensors 11, a cloud analysis device 12, a cloud data ledger module 13 and a cloud supplying module 14.

The sensors 11 are disposed on the target cutting machine T and connected to a plurality of components of the target cutting machine T respectively. The target cutting machine T implements a machining process for a workpiece and the sensors 11 detects the operational data of the components corresponding thereto and provide the operational data of the components.

The difference between the embodiment and the previous embodiment is that the cloud analysis device 2 can be disposed at the customer's location, connected to the sensors 11, and connected to the cloud data ledger module 13 and the cloud supplying module 14 via a network N. Similarly, the cloud analysis device 12 can also generate the analysis results of the components by analyzing the operational data of the components via distributed ledger technology, and generate the healthy statuses of the components according to the analysis results of the components.

The cloud data ledger module 14 records the healthy statuses of the components.

In addition, the cloud supplying module 14 can further calculate reward values or cash back according to the data volume of the healthy statuses recorded in the cloud data ledger module 13 and record the reward values or cash back in the user account of a user device U.

Similarly, the cloud supplying module 14 can generate the component purchase reminder signal RS according to the healthy statuses of the components and a purchase condition which the user agrees, and transmits the component purchase reminder signal RS to the user device U.

Then, the user device U can transmit an order signal OS according to the component purchase reminder signal RS to the cloud supplying module 14 and the cloud supplying module 14 generates a transaction record according to the order signal OS.

As described above, the cloud analysis device 12 can be disposed at the customer's location to directly analyze the operational data of the components and then generate the healthy statuses of the components. Afterward, the healthy statuses of the components can be transmitted to the cloud data ledger module 13 and the cloud supplying module 14 can calculate the reward values or cash back according to the data volume of the healthy statuses recorded in the cloud data ledger module 13.

In the embodiment, the DLT-based system 1 can further include an inventory data ledger module 15. The inventory data ledger module 15 records the inventory of the components and updates the inventory of the components according to the transaction records. In this way, the supplier of the cutting machines and the components thereof can always know the inventory of the components and prepare enough spares for the components in order to avoid that the inventory of the components is insufficient.

Further, the cloud analysis device 12 can further generate the test data of the components by analyzing the healthy statuses of the components via distributed ledger technology. Via the above method, the cloud analysis device 12 can obtain the actual performances of the target cutting machine T and the components thereof according to the operational data provided by the target cutting machine T, which can serve as the references for marketing the products and improving the performances thereof.

The embodiment just exemplifies the disclosure and is not intended to limit the scope of the disclosure. Any equivalent modification and variation according to the spirit of the disclosure is to be also included within the scope of the following claims and their equivalents.

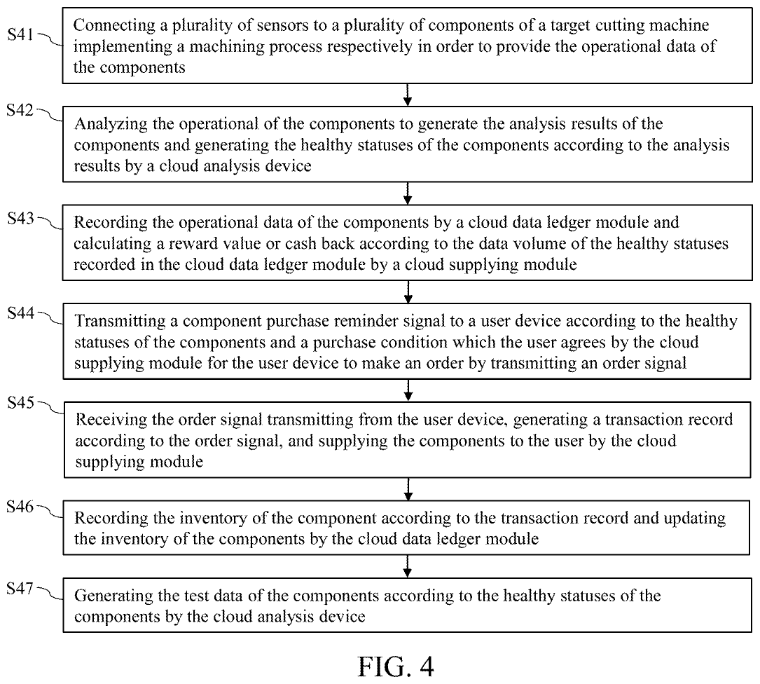

Please refer to FIG. 4, which is a flow chart of the second embodiment of the disclosure. As shown in FIG. 4, the cutting machine supplying & marketing method in accordance with the second embodiment may include the following steps:

Step 41: connecting a plurality of sensors to a plurality of components of a target cutting machine implementing a machining process respectively in order to provide the operational data of the components.

Step 42: analyzing the operational of the components to generate the analysis results of the components and generating the healthy statuses of the components according to the analysis results by a cloud analysis device.

Step 43: recording the operational data of the components by a cloud data ledger module and calculating a reward value or cash back according to the data volume of the healthy statuses recorded in the cloud data ledger module by a cloud supplying module.

Step 44: transmitting a component purchase reminder signal to a user device according to the healthy statuses of the components and a purchase condition which the user agrees by the cloud supplying module for the user device to make an order by transmitting an order signal.

Step 45: receiving the order signal transmitting from the user device, generating a transaction record according to the order signal, and supplying the components to the user by the cloud supplying module.

Step 46: recording the inventory of the component according to the transaction record and updating the inventory of the components by the cloud data ledger module.

Step 47: generating the test data of the components according to the healthy statuses of the components by the cloud analysis device.

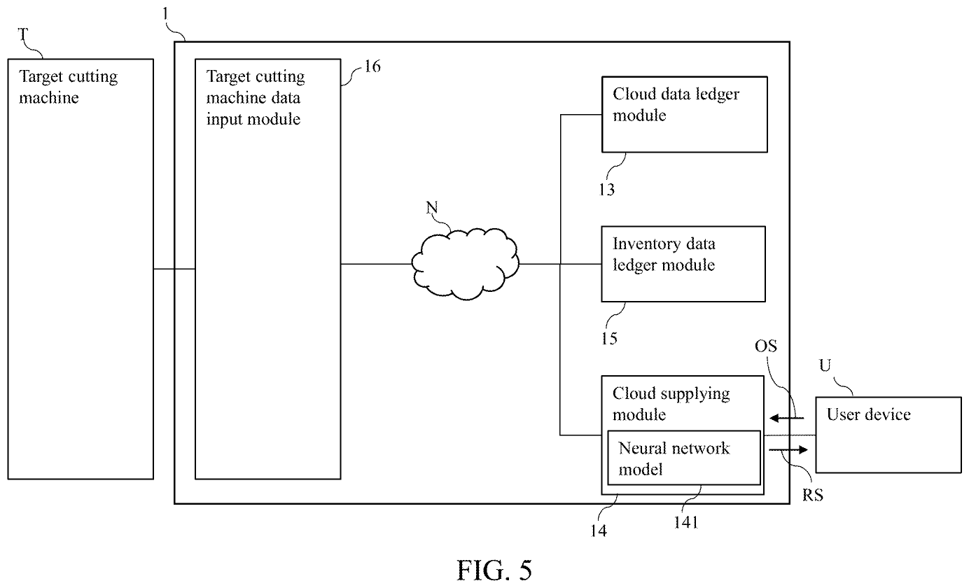

Please refer to FIG. 5, which is a block diagram of a cutting machine supplying & marketing DLT-based system in accordance with a third embodiment of the disclosure. As shown in FIG. 5, the system 1 includes a target cutting machine data input module 16, a cloud data ledger module 13, a cloud supplying module 14 and an inventory data ledger module 15.

The target cutting machine data input module 16 is connected to a target cutting machine T, and connected to the cloud data ledger module 13 and the cloud supplying module 14 via a network N. The target cutting machine data input module 16 is for a user to input the basic data of the components, the workpiece and the operational status of the target cutting machine T. In one embodiment, the components may include one or more of a bandsaw, a steel brush, a cutting oil tank, a gear box, a motor, a spindle, etc. In one embodiment, the basic data of the components of the target cutting machine T include component model. The basic data of the workpieces may include one or more of workpiece model, workpiece shape, workpiece size, workpiece material, etc. The basic data of the operational status may include total cutting hours.

The cloud data ledger module 13 records the basic data.

The cloud supplying module 14 compares the basic data with the estimated component mechanical consumption data to generate a comparison result. When the comparison result is less than a threshold, the cloud supplying module 14 transmits a component purchase reminder signal RS to a user device U. More specifically, the cloud supplying module 14 can generate the component purchase reminder signal RS according to the estimated component mechanical consumption data and a purchase condition which the user agrees. For example, if the purchase condition includes purchasing a spare for one component in advance when the residual service life of the components is less than one month, the cloud supplying module 14 can generate the component purchase reminder signal RS and transmit the component purchase reminder signal RS to the user device U when the estimated component mechanical consumption data show that residual service life of the component is less than one month.

Then, the user device U transmits an order signal OS to the cloud supplying module 14 according to the component purchase reminder signal RS and the cloud supplying module 14 generates a transaction record according to the order signal OS. Via the above method, the user can purchase enough spares for the components before the components need to be replaced, so the cutting machines of the user can always work normally.

In addition, the cloud supplying module 14 can further calculate reward values or cash back according to the data volume of the basic data recorded in the cloud data ledger module 13 and record the reward values or cash back in the user account of the user device U. Via the above method, when the user transmits the order signal OS to make the order, the reward values or cash back can serve as the discount in the payment, so the user will be more willing to provide more basic data for analysis, and purchase more cutting machines and the components thereof. Therefore, the above method can also effectively increase the sales volume of the supplier's products.

Moreover, the cloud supplying module 14 further includes a neural network model 141. The cloud supplying module 14 compares the basic data of the target cutting machine T with the basic data of a plurality of default cutting machines stored in a cloud database via the neural network model 141 to calculate an estimated machining parameter, which may include an estimated cutting tool mechanical consumption rate. Afterward, the target cutting machine T implements a machining process according to the estimated machining parameter. Next, the cloud supplying module 14 executes a comparison process according to the actual mechanical consumption rate of the target cutting machine T implementing the machining process in order to compare the estimated cutting tool mechanical consumption rate with the actual mechanical consumption rate and then generate a suggested machining parameter. Then, the cloud supplying module 14 transmits the suggested machining parameter to the target cutting machine T for the target cutting machine T to execute the machining process by the suggested machining parameter. Via the above method, the DLT-based system 1 can actively provide the suggested machining parameters for the target cutting machine T, so the target cutting machine T can operate according to the best machining parameters, which can increase the satisfaction of the user and further increase the sales volume of the supplier's products.

In the embodiment, the DLT-based system 1 further includes an inventory data ledger module 15. The inventory data ledger module 15 records the inventory of the components and updates the inventory of the components according to the transaction record. In this way, the supplier of the cutting machines and the components thereof can always know the inventory of the components and prepare enough spares for the components in order to avoid that the inventory of the components is insufficient.

The embodiment just exemplifies the disclosure and is not intended to limit the scope of the disclosure. Any equivalent modification and variation according to the spirit of the disclosure is to be also included within the scope of the following claims and their equivalents.

It is worthy to point out that the currently available marketing systems can provide only the common marketing management and inventory management functions, but cannot actively promote the products. Thus, the currently available marketing systems cannot effectively increase the sales volume of the cutting machines. On the contrary, according to one embodiment of the disclosure, the DLT-based system can calculate the reward values or cash back according to the data volume of the operational data or the basic data, provided by the user device, recorded in the cloud data ledger module, and record the reward values or cash back in the user account of the user device. Therefore, the user will be more willing to purchase more cutting machines and the components thereof, so the sales volume of the supplier's products can be effectively increased.

Also, according to one embodiment of the disclosure, the DLT-based system can actively provide the suggested machining parameters for the cutting machines of the user, so the cutting machines can operate according to the best machining parameters, which can increase the satisfaction of the user and further increase the sales volume of the supplier's products.

Besides, the currently available marketing systems can provide only the common marketing management and inventory management functions, but cannot acquire the operational data of the cutting machines from the customers. Therefore, the suppliers cannot understand the actual performances of the cutting machines and the components thereof. On the contrary, according to one embodiment, the DLT-based system can generate the test data of the components according to the healthy statuses thereof in order to obtain the actual performances of the cutting machines and the components thereof, which can serve as the references for marketing the products and improving the performances thereof.

Moreover, the currently available marketing systems can record only the inventory of the cutting machines and the components thereof, but cannot obtain the demand of the customers, so the inventory of the cutting machines tends to be insufficient. On the contrary, according to one embodiment of the disclosure, the DLT-based system can acquire the demand of the user and keep updating the inventory of all components according to the transaction records, so the inventory of all components can always be enough.

Furthermore, according to one embodiment of the disclosure, the DLT-based system can transmit the component purchase reminder signals to the user device according to a purchase condition which the user agrees and the healthy statuses or the estimated component mechanical consumption data of the component for the user device to automatically make orders. Thus, the user can always have enough components, so the cutting machines of the user can always work normally. As described above, the DLT-based system according to the embodiments of the disclosure can achieve unpredictable technical effects.

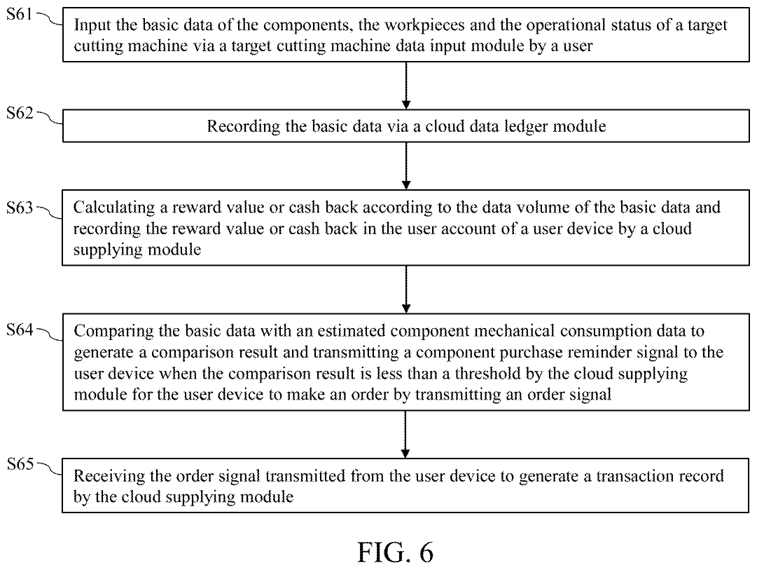

Please refer to FIG. 6, which is a first flow chart of the third embodiment of the disclosure. As shown in FIG. 6, the cutting machine supplying & marketing method in accordance with the third embodiment may include the following steps:

Step 61: input the basic data of the components, the workpieces and the operational status of a target cutting machine via a target cutting machine data input module by a user.

Step 62: recording the basic data via a cloud data ledger module.

Step 63: calculating a reward value or cash back according to the data volume of the basic data and recording the reward value or cash back in the user account of a user device by a cloud supplying module.

Step 64: comparing the basic data with an estimated component mechanical consumption data to generate a comparison result and transmitting a component purchase reminder signal to the user device when the comparison result is less than a threshold by the cloud supplying module for the user device to make an order by transmitting an order signal.

Step 65: receiving the order signal transmitted from the user device to generate a transaction record by the cloud supplying module.

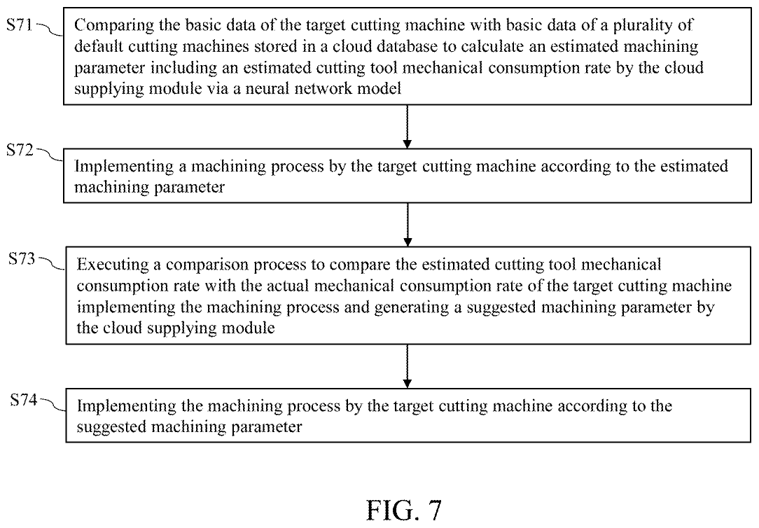

Please refer to FIG. 7, which is a second flow chart of the third embodiment of the disclosure. As shown in FIG. 7, the method of generating the suggested machining parameters in accordance with the third embodiment may further include the following steps:

Step 71: comparing the basic data of the target cutting machine with basic data of a plurality of default cutting machines stored in a cloud database to calculate an estimated machining parameter including an estimated cutting tool mechanical consumption rate by the cloud supplying module via a neural network model.

Step 72: implementing a machining process by the target cutting machine according to the estimated machining parameter.

Step 73: executing a comparison process to compare the estimated cutting tool mechanical consumption rate with the actual mechanical consumption rate of the target cutting machine implementing the machining process and generating a suggested machining parameter by the cloud supplying module.

Step 74: implementing the machining process by the target cutting machine according to the suggested machining parameter.

To sum up, according to one embodiment of the disclosure, the DLT-based system can transmit the component purchase reminder signals to the user device according to the purchase condition which the user agrees and the healthy statuses or the estimated component mechanical consumption data of the component for the user device to automatically make orders. Thus, the user can always have enough components, so the cutting machines of the user can always work normally.

Also, according to one embodiment of the disclosure, the DLT-based system can calculate the reward values or cash back according to the data volume of the operational data or the basic data, provided by the user device, recorded in the cloud data ledger module, and record the reward values or cash back in the user account of the user device. Therefore, the user will be more willing to purchase more cutting machines and the components thereof, so the sales volume of the supplier's products can be effectively increased.

Besides, according to one embodiment of the disclosure, the DLT-based system can actively provide the suggested machining parameters for the cutting machines of the user, so the cutting machines can operate according to the best machining parameters, which can increase the satisfaction of the user and further increase the sales volume of the supplier's products.

Moreover, according to one embodiment of the disclosure, the DLT-based system can acquire the demand of the user and keep updating the inventory of all components according to the transaction records, so the inventory of all components can always be enough.

Furthermore, according to one embodiment, the DLT-based system can generate the test data of the components according to the healthy statuses thereof in order to obtain the actual performances of the cutting machines and the components thereof, which can serve as the references for marketing the products and improving the performances thereof.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A cutting machine supplying & marketing DLT(Distributed ledger technology)-based system, comprising:
a target cutting machine data input module receiving basic data of components, workpieces and an operational status of a target cutting machine;
a cloud data ledger module recording the basic data; and
a cloud supplying module comparing the basic data with an estimated component mechanical consumption data to generate a comparison result, wherein when the comparison result is less than a threshold, the cloud supplying module transmits a component purchase reminder signal to a user device for the user device to make an order;
wherein the cloud supplying module receives an order signal transmitted from the user device in order to generate a transaction record.

2. The DLT-based system of claim 1, wherein the cloud supplying module calculates a reward value or a cash back according to a data volume of the basic data recorded in the cloud data ledger module.

3. The DLT-based system of claim 1, further comprising an inventory data ledger module, wherein the inventory data ledger module records an inventory of the components and update the inventory of the components according to the transaction record.

4. The DLT-based system of claim 1, wherein the cloud supplying module automatically generates the component purchase reminder signal according to the estimated component mechanical consumption data and a purchase condition.

5. The DLT-based system of claim 1, wherein the cloud supplying module comprises a neural network model, and the cloud supplying module compares the basic data of the target cutting machine with basic data of a plurality of default cutting machines stored in a cloud database to calculate an estimated machining parameter comprising an estimated cutting tool mechanical consumption rate, and the cloud supplying module executes a comparison process according to an actual mechanical consumption rate of the target cutting machine implementing a machining process in order to compare the estimated cutting tool mechanical consumption rate with the actual mechanical consumption rate and then generate a suggested machining parameter, and the target cutting machine executes the machining process by the suggested machining parameter.

6. A cutting machine supplying & marketing DLT-based method, comprising:
receiving basic data of components, workpieces and an operational status of a target cutting machine by a target cutting machine data input module;
recording the basic data by a cloud data ledger module;
comparing the basic data with an estimated component mechanical consumption data to generate a comparison result and transmitting a component purchase reminder signal to a user device when the comparison result is less than a threshold by a cloud supplying module for the user device to make an order; and
receiving an order signal transmitted from the user device and generating a transaction record according to the order signal by the cloud supplying module.

7. The DLT-based method of claim 6, further comprising:
calculating a reward value or a cash back according to a data volume of the basic data recorded in the cloud data ledger module by the cloud supplying module.

8. The DLT-based method of claim 6, further comprising:
recording an inventory of the components and updating the inventory of the components according to the transaction record by an inventory data ledger module.

9. The DLT-based method of claim 6, wherein a step of comparing the basic data with the estimated component mechanical consumption data to generate the comparison result and transmitting the component purchase reminder signal to the user device when the comparison result is less than the threshold by the cloud supplying module for the user device to make the order further comprises:
automatically generating the component purchase reminder signal according to the estimated component mechanical consumption data and a purchase condition by the cloud supplying module.

10. The DLT-based method of claim 6, further comprising:
comparing the basic data of the target cutting machine with basic data of a plurality of default cutting machines stored in a cloud database to calculate an estimated machining parameter comprising an estimated cutting tool mechanical consumption rate by the cloud supplying module via a neural network model;
executing a comparison process to compare the estimated cutting tool mechanical consumption rate with an actual mechanical consumption rate, of the target cutting machine implementing a machining process, and generating a suggested machining parameter by the cloud supplying module; and
executing the machining process by the target cutting machine according to the suggested machining parameter.

11. A cutting machine supplying & marketing DLT-based system, comprising:
a plurality of sensors, connected to a plurality of components of a target cutting machine implementing a machining process respectively to provide operational data of the components;
a cloud analysis device analyzing the operational data of the components to generate analysis results of the components and generate healthy statuses of the components according to the analysis results of the components;
a cloud data ledger module recording the healthy statuses of the components; and
a cloud supplying module transmitting a component purchase reminder signal to a user device according to the healthy statuses of the components for the user device to make an order;
wherein the cloud supplying module receives an order signal transmitted from the user device to generate a transaction record.

12. The DLT-based system of claim 11, wherein the cloud supplying module calculates a reward value or a cash back according to a data volume of the healthy statuses recorded in the cloud data ledger module.

13. The DLT-based system of claim 11, further comprising an inventory data ledger module, wherein the inventory data ledger module records an inventory of the components and update the inventory of the components according to the transaction record.

14. The DLT-based system of claim 11, wherein the cloud supplying module automatically generates the component purchase reminder signal according to the healthy statuses of the components and a purchase condition.

15. The DLT-based system of claim 11, wherein the cloud supplying module generates test data of the components according to the healthy statuses of the components.

16. A cutting machine supplying & marketing DLT-based method, comprising:
connecting a plurality of sensors to a plurality of components of a target cutting machine implementing a machining process respectively to provide operational data of the components;
analyzing the operational data of the components to generate analysis results of the components and generating healthy statuses of the components according to the analysis results of the components by a cloud analysis device;
recording the healthy statuses of the components by a cloud data ledger module;
transmitting a component purchase reminder signal to a user device according to the healthy statuses of the components by a cloud supplying module for the user device to make an order; and
receiving an order signal transmitted from the user device to generate a transaction record by the cloud supplying module.

17. The DLT-based method of claim 16, further comprising:
calculating a reward value or a cash back according to a data volume of the healthy statuses recorded in the cloud data ledger module by the cloud supplying module.

18. The DLT-based method of claim 16, further comprising:
recording an inventory of the components and updating the inventory of the components according to the transaction record by an inventory data ledger module.

19. The DLT-based method of claim 16, wherein a step of transmitting the component purchase reminder signal to the user device according to the healthy statuses of the components by the cloud supplying module for the user device to make the order further comprises:
automatically generating the component purchase reminder signal according to the healthy statuses of the components and a purchase condition by the cloud supplying module.

20. The DLT-based method of claim 16, further comprising:
generating test data of the components according to the healthy statuses of the components by the cloud analysis device.
